(19) United States
(12) Patent Application Publication
(10) Pub. No.: US 2010/0084203 A1
(43) Pub. Date: Apr. 8, 2010

(54) ELECTRIC PEN

(75) Inventor: Ke-Ren Peng, Xi'an (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/572,279

(22) Filed: Oct. 2, 2009

(30) Foreign Application Priority Data
Oct. 3, 2008 (TW) 97217769

(51) Int. Cl. G06F 3/033; H04B 7/00

(52) U.S. Cl. 178/19.01; 455/41.3

(57) ABSTRACT

An electronic pen is provided. The electronic pen can capture the pressure, speed and motion of its tip, thereby reflecting the strength and muscularity of the handwriting.

### RELATED APPLICATIONS

This application claims priority to Taiwan Application Serial Number 97217769, filed Oct. 3, 2008, which is herein incorporated by reference.

### BACKGROUND

1. Technical Field

The present disclosure relates to an electronic device, and more particularly, an electronic pen.

2. Description of Related Art

With the fast development of the electronics industry and information technology, the application of handwriting recognition has become more popular. The tablet and stylus can be used to replace a keyboard or both a mouse and a keyboard, by using the tablet and stylus in two modes: Pointing mode: The stylus is used as a pointing device as above. On-line Handwriting recognition mode: The strokes made with the stylus are analyzed by software that recognizes the shapes of the strokes or marks as handwritten characters.

However, handwriting input devices are incapable of capturing the details of the strength and muscularity of the handwriting. Therefore, the characters are then input as text, as if from a keyboard.

In view of the foregoing, there is an urgent need in the related field to provide a novel electronic pen capable of capturing the pressure, speed, and motion of the pen tip, thereby reflecting the strength and muscularity of the handwriting.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

In one aspect, the present disclosure is directed to an electronic pen capable of capturing the pressure, speed, and motion of the pen tip, thereby reflecting the strength and muscularity of the handwriting.

According to one embodiment of the present invention, the electronic pen comprises a pen body, a track sensor, a pressure sensor, a speed calculator, a signal processor and a transmission interface. The pen body has a pen tip fitted to the pen body.

In this embodiment, the track sensor can sense the track of movement of the pen tip. The pressure sensor can sense the pressure against the pen tip. The speed calculator can calculate the speed of movement according to the track of movement of the pen tip. The signal processor can convert said track of movement, speed of movement and pressure against the pen tip into a handwriting signal. The transmission interface can communicate the handwriting signal to the electronic device.

In this way, the pressure, speed, and motion of the pen tip can be captured by the electronic pen tip and then transferred to the electronic device. The electronic device can display the details of the strength and muscularity of the handwriting written with the electronic pen.

Many of the attendant features will be more readily appreciated as the same becomes better understood by reference to the following detailed description considered in connection with the accompanying drawings.

### BRIEF DESCRIPTION OF THE DRAWINGS

The present invention will be better understood from the following detailed description read in light of the accompanying drawings, wherein:

FIG. 1 is a schematic diagram illustrating an electronic pen according to one embodiment of the present invention;

FIG. 2 is a functional block diagram of the electronic pen of FIG. 1; is FIG. 3 is a functional block diagram of the track sensor of FIG. 2;

FIG. 4 is a perspective diagram illustrating a portion of the electronic pen of FIG. 1;

FIG. 5 is a schematic diagram illustrating the communication between the electronic pen of FIG. 4 and an electronic device; and

FIG. 6 is a functional block diagram of the electronic pen of FIG. 5.

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the meaning of “in” includes “in” and “on” unless the context clearly dictates otherwise.

As used herein, the terms “comprise or comprising”, “include or including”, “have or having”, “contain or containing” and the like are to be understood to be open-ended, i.e., to mean including but not limited to.

In our daily life, signatures are required to confirm the identity of the signer or express acknowledgement. Until now, signing are mostly done on papers with ordinary ball-point pens. In the past years, writing pads are being developed to record the writing or handwriting (hereinafter called “handwriting” or “script”). Unfortunately, conventional writing pads can only be used to record a rough outline of the characters inscribed by the user and are unable to reflect the actual penmanship of the user. The penmanship may include the muscular strength exerted by, the speed of, and the movement momentum of inscribing the handwriting. Therefore, more information relating to the action of inscribing may be required to entirely reflect the penmanship of the handwriting; such information may include the muscular strength exerted by, the speed of, and the movement momentum of inscribing the handwriting.

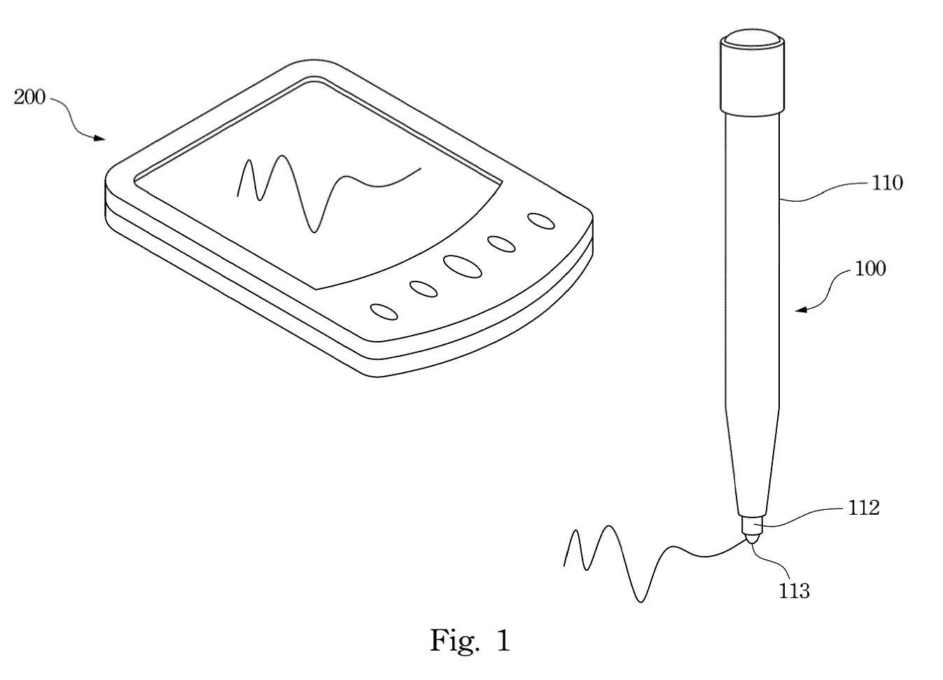

FIG. 1 is a schematic diagram illustrating an electronic pen according to one embodiment of the present invention. As shown in FIG. 1, an electronic pen 100 comprises a pen body 110 having a pen tip 112. To make the pen 100, the pen tip 112 is fitted to the pen body 110.

In operation, a user may use the electronic pen 100 to inscribe on any surface. The electronic pen 100 can capture information such as the pressure against the pen tip 112 and the speed and motion of the pen tip 112, and then transfer said information to the electronic device 200. The electronic device 200 can display the handwriting being inscribed by the electronic pen 100 while substantially entirely presenting the exerted muscular strength and the movement momentum of the handwriting.

Furthermore, the pen tip 112 may comprise a ball 113. For example, the ball 113 may be a wearproof or hardwearing mercury-shaped sphere or spheroid. It should be appreciated that said sphere and spheroid are only examples and should not be regarded as limitations of the present invention. Those with ordinary skill in the art may design a pen tip 112 depending on the is desired application.

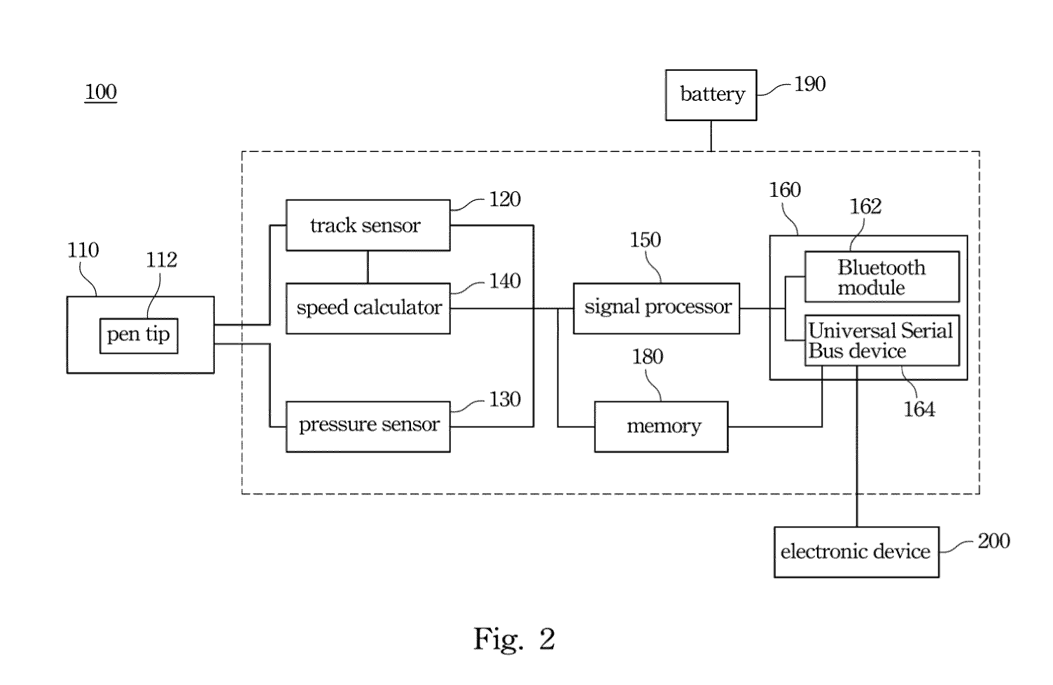

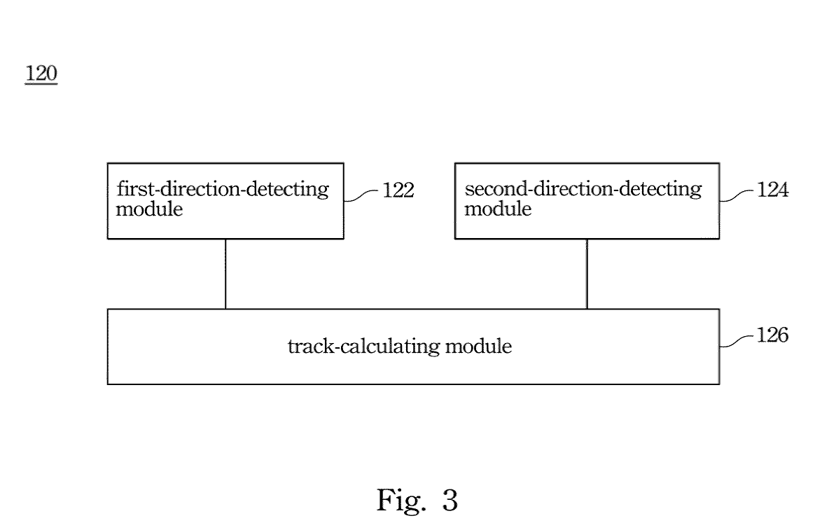

To provide a more detail description regarding the function of the electronic pen 100, FIG. 2 is presented to illustrate the construction of the electronic pen 100.

FIG. 2 is a functional block diagram of the electronic pen of FIG. 1. The electronic pen 100, as shown in FIG. 2, comprises a pen body 110, a track sensor 120, a pressure sensor 130, a speed calculator 140, a signal processor 150, and a transmission interface 160. The pen body 110 has a pen tip 112. For example, the speed calculator 140 may be a counter/rate meter or the like, and the signal processor 150 may be a microprocessor or the like.

In this embodiment, the track sensor 120 can sense the track of movement of the pen tip 112. The pressure sensor 130 can sense the pressure against the pen tip 112. The speed calculator 140 can calculate the speed of movement according to the track of movement of the pen tip 112. The signal processor 150 can convert the track of movement of the pen tip 112, the speed of movement of the pen tip 112 and the pressure against the pen tip 112 into a handwriting signal. The transmission interface 160 communicates the handwriting signal to the electronic device 200. The electronic device 200 can be, for example, a display screen, a personal computer, a mobile phone, or a personal digital assistant (PDA), etc. In this way, the electronic device 200 can display the handwriting according to the handwriting signal.

It should be appreciated that, the strength exerted by a user during a stroke or the speed of making the stroke may affect the light and shades and width of the script. From the perspective of handwriting style, the script would become thicker when the pressure against the pen tip increases; on the contrary, the script would become thinner when the pressure against the pen tip decreases. Furthermore, the script would become lighter when the speed of the movement of the pen tip is increased; on the contrary, the script would become darker when the speed of the movement of the pen tip is reduced.

In fact, the penmanship varies from person to person depending on one's habit of writing. For example, Yan style established by Yan Zhenqing, a reputable Chinese calligrapher, emphasizes on strength, boldness and grandness; while the calligraphy of Wang Xizhi, Calligraphy Sage, is vigorous yet elegant and is often characterized by writing with more fluidity. It is believed that the penmanship may represent the personality of the writer; thus, sampling the rough outline of the handwriting is not able to manifest the beauty of the script and the personality of the writer.

The electronic pen 100 according to embodiments of the present invention may capture not only the track of movement of the pen tip 112, but also the pressure against the pen tip 112 and the speed of movement of the pen tip 112. Hence, the electronic device 200 may vividly display the light and shades and width of the script and thus substantially completely reflect the exerted muscular strength and the movement momentum of the handwriting. Moreover, the electronic pen 100 may be used as a signing tool, and it can provide better ability to identify and distinguish among different persons' handwriting, with the benefit of, among other things, verifying the authenticity of the signature of a particular person.

According to the above-mentioned embodiments, the electronic pen 100 may convert the complicated characters into the handwriting signal. The is handwriting signal is an electric signal, and presenting the actual handwriting of the user through the electronic device 200 can eliminate the need to use paper. In addition, electronic pen 100 is a compact and easily portable tool having the shape of a pen, which is quite handy for almost everyone who is used to writing with a pen. As such, the users have no need to alter their writing habits. Thus, it is clear that the electronic pen 100 may be widely used in many applications.

The electronic pen 100 in itself may be used to record the handwriting that is being inscribed. With reference to FIG. 2, the electronic pen 100 may further comprise a memory 180. The memory 180 can store the track of movement of the pen tip 112, the speed of movement of the pen tip 112 and the pressure against the pen tip 112 as digital data.

In this way, the electronic device 200 can read the digital data stored in the memory 180 through the transmission interface 160. Thereafter, the electronic device 200 can convert the digital data into handwriting information and render the handwriting.

In other embodiments, the electronic pen 100 may be used as a thumb drive. In other words, the memory 180 may be used to store other data. For example, the electronic pen 100 may have a Universal Serial Bus device (USB device) 164, and the USB device 164 may be connected to the electronic device 200. Then, the memory 180 may be used to store the data stored in the electronic device 200.

In this way, the electronic pen 100 can be used as a handy storage device in addition to a convenient handwriting tool.

The transmission interface 160 serves as a medium for establishing a communication between the electronic pen 100 and the electronic device 200. Hence, a more detailed description regarding the transmission interface 160 is provided hereinafter.

Still referring to FIG. 2, the transmission interface 160, as shown, can comprise a Bluetooth module 162. The Bluetooth module 162 can communicate the handwriting signal according to a Bluetooth standard to the electronic device 200. Alternatively, the transmission interface 160 can comprise a USB device 164. Said examples of the transmission interface 160 are merely provided for illustration and exemplification, but are not used to limit the scope of the present invention. Those with ordinary skill in the art may design a transmission interface 160 depending on the desired application.

In another aspect, the electronic pen 100 is an electronic device, and it must be provided with sufficient electric power to perform at least the above-mentioned functions. A detailed description regarding the power supply of the electronic pen 100 is provided hereinafter in conjunction with FIG. 2. As shown in FIG. 2, the electronic pen 100 may further comprise a battery 190. The battery 190 can provide the electronic pen 100 with the electric power needed.

For example, the battery 190 can supply electric power to the Bluetooth module 162, so that the Bluetooth module 162 would have sufficient energy to communicate the handwriting signal to the electronic device 200.

In this embodiment, the Universal Serial Bus device 164 can be connected to the electronic device 200 for charging the battery 190, so that the is battery 190 receives electric power from the electronic device 200 via the Universal Serial Bus device 164 and stores the electric power. One of ordinary skill in the art will appreciate that the above examples are provided for illustrative purposes only to further explain methods to charge the battery 190 and are not meant to limit the present invention in any manner. In another embodiment, the electronic pen 100 can be charged through a wireless charging system or the like.

The battery 190 may be, for example, a Nickel-Cadmium battery, a Nickel-Metal Hydride battery, a Lithium-ion battery or the like. Nickel-Cadmium batteries are cheap in cost, but they have toxicity and suffer from memory effect. Nickel-Metal Hydride batteries are fast charged, but they have a somewhat higher self-discharge rate, are difficult to operate at high temperature and suffer from a slight memory effect. Lithium-ion batteries have satisfying power-to-weight ratios, no memory effect, and a slow loss of charge when not in use. However, Lithium-ion batteries are not as durable as Nickel-Metal Hydride or Nickel-Cadmium designs, and can be extremely dangerous if treated wrongly. They may explode if overheated or charged to an excessively high voltage. Furthermore, they may be irreversibly damaged if discharged to below a certain voltage. Said examples of the battery 190 are merely provided for illustration and exemplification, and are not used to limit the scope of the present invention. Those with ordinary skill in the art may design a battery depending on the desired application.

Moreover, the track sensor 120 serves as a means to get the handwriting. Hence, a more detailed description regarding the track sensor 120 is provided hereinafter.

FIG. 3 is a functional block diagram of the track sensor of FIG. 2. With reference to FIG. 3, the track sensor 120 comprises a first-direction-detecting module 122, a second-direction-detecting module 124 and a track-calculating module 126.

In this embodiment, the first-direction-detecting module 122 can detect a motion vector component in a first direction of a motion vector, wherein the motion vector represents the movement of the pen tip 112. The second-direction-detecting module 124 can detect a motion vector component in a second direction of the motion vector, wherein the first direction and the second direction are perpendicular to each other. The track-calculating module 126 can calculate the track of movement of the pen tip 112 according to the motion vector component in the first direction and the motion vector component in the second direction.

In this way, the track sensor 120 can substantially completely measure all movement of the pen tip 112 on a plane, no matter what a user writes in any manner.

In the track sensor 120, the first-direction-detecting module 122, the second-direction-detecting module 124 and the track-calculating module 126 may be made of hardware, software, and/or firmware. For example, if a designer determines that speed and accuracy are paramount, the designer may opt for a mainly hardware and/or firmware implementation; alternatively, if flexibility is paramount, the designer may opt for a mainly software implementation; or still alternatively, the designer may opt for some combination of hardware, software, and/or firmware.

In one embodiment, a screen of the electronic device 200 can be used to render the handwriting inscribed by the electronic pen 100. Moreover, the electronic pen 100 can function as an eraser, so as to erase the handwriting shown on the electronic device 200. For a more complete understanding of the eraser of the electronic pen 100, one or more examples of the eraser are provided hereinafter.

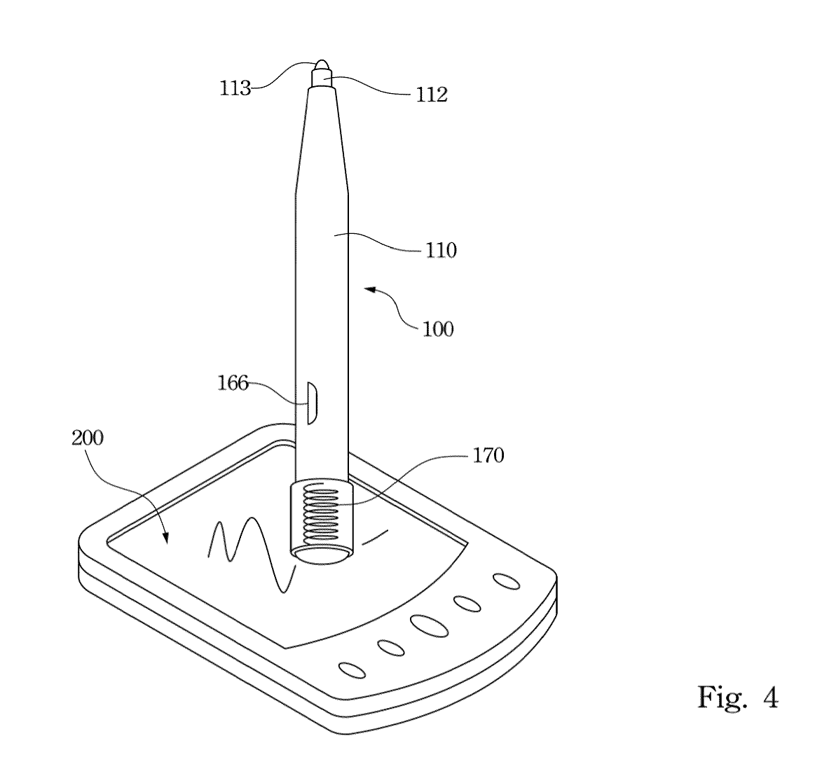

FIG. 4 is a perspective diagram illustrating a portion of the electronic pen of FIG. 1. In FIG. 4, the electronic pen 100 comprises an electromagnetic coil 170. The electromagnetic coil 170 is disposed in the pen body 110 and is adjacent to the end of the pen body 110, wherein the end is opposite to the pen tip 112.

Furthermore, an electromagnetic field may be generated in the screen of the electronic device 200 by means of electro-magnetic resonance technology. When the end of the pen body 110 is close to or touches the screen, the electronic device 200 responds to change in the magnetic field created by the electromagnetic coil 170 and executes an adapted function, such as erasing a portion of the handwriting corresponding to the responsive region of the screen.

Alternatively or additionally, a capacitive touch screen may be adopted in the electronic device 200. The capacitive touch screen has a sensor typically made of glass coated with a transparent conductor such as indium tin oxide (ITO). This type of sensor is basically a capacitor. Since the human body also conducts electricity, a touch on the surface of the sensor will affect the electric field and create a measurable change in the capacitance of the device. Like the stylus used in the defunct Capacitance Electronic Disc (CED) videodisc, these sensors can work on proximity of the conductive medium (finger), and do not have to be directly touched to be triggered. However, the capacitive touch screen only responds to finger contact and will not work with a gloved hand or pen stylus unless the stylus is conductive.

Accordingly, the pen body 110 comprises conductive material, such as conductive metal and/or electrically conductive plastics. For example, the pen body 110 is entirely conductive metal, or the end of the pen body 110 contains electrically conductive plastics. It should be appreciated that said conductive metal and/or electrically conductive plastics are only examples and should not be regarded as limitation of the present invention. Those with ordinary skill in the art may select the conductive material of the pen body 110 depending on the desired application.

Since a user grasps the electronic pen 100 to conduct electricity to the pen body 110 and use the end of the pen body 110 to touch the surface of the capacitive touch screen of the electronic device 200, the electronic device 200 can measure change in the capacitance of its capacitive touch screen, so as to execute an adapted function, such as erasing a portion of the handwriting corresponding to the touch region of the capacitive touch screen.

Alternatively or additionally, a resistive touch screen may be adopted in the electronic device 200. The resistive touch screen has a panel that is composed of several layers, one embodiment of which is two thin, metallic, electrically conductive layers separated by a narrow gap. When an object, such as a finger, presses down on a point on the panel's outer surface the two metallic layers become connected at that point: the panel then behaves as a pair of voltage dividers with connected outputs. This causes a change in the electrical current that is registered as a touch event and sent to the controller for processing.

Since a user uses the end of the pen body 110 to press down on a point on the resistive touch screen of the electronic device 200, the electronic device 200 can detect the point, so as to execute an adapted function, such as erasing a portion of the handwriting corresponding to the point.

In FIG. 4, the electronic pen 100 comprises a connection interface 166. In this embodiment, the connection interface 166 is disposed in the pen body 110. For example, the connection interface is a mini USB port. It should be appreciated that said mini USB port is one example for illustrative purposes. Those with ordinary skill in the art may design the conductive material of the pen body 110 depending on the desired application.

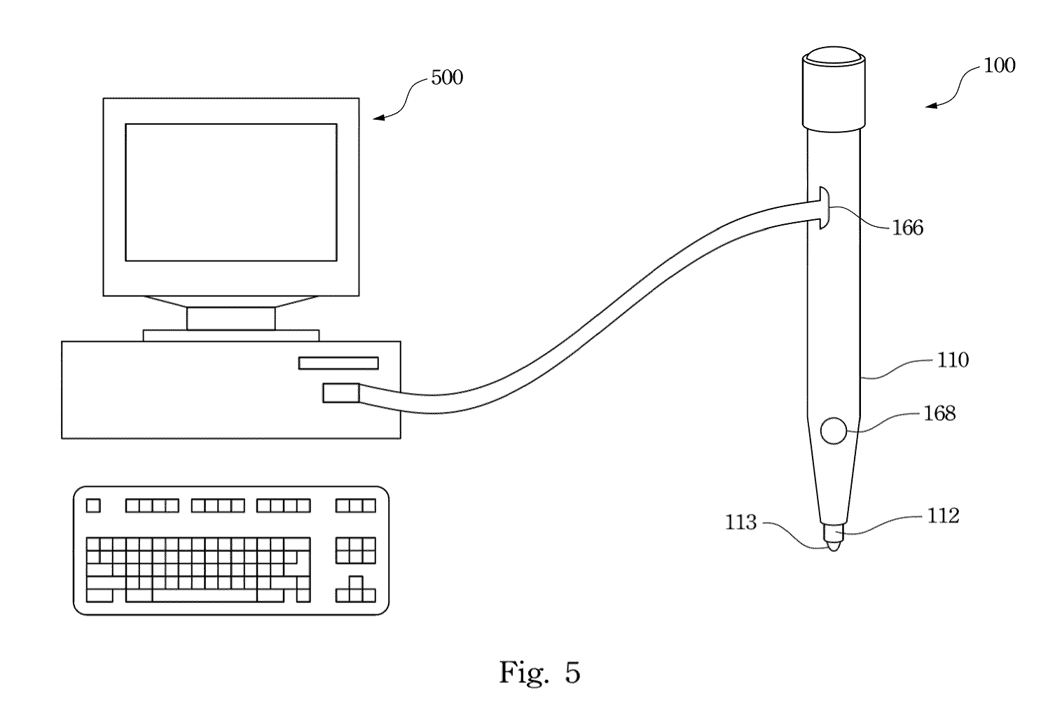

FIG. 5 is a schematic diagram illustrating the communication between the electronic pen of FIG. 4 and an electronic device. In FIG. 5, the electronic device 500 is a computer, such as a PC. The electronic pen 100 is connected to the electronic device 500 via a transmission line 510, where one end of the transmission line 510 is connected to the connection interface 166 of the electronic pen 100, and another end of the transmission line 510 is connected to the electronic device 500.

In operation, the electronic pen 100 can capture information such as the pressure against the pen tip 112 and the speed and motion of the pen tip 112, and then transfer said information to the electronic device 500. The electronic device 500 can display the handwriting being inscribed by the electronic pen 100 while substantially entirely representing the exerted muscular strength of the handwriting.

In one embodiment, a screen of the electronic device 500 can be used to render the handwriting inscribed by the electronic pen 100. Moreover, the electronic pen 100 can function as an eraser, so as to erase the handwriting shown on the electronic device 500. For a more complete understanding of the eraser of the electronic pen 500, one or more examples of the eraser are provided hereinafter.

In FIG. 5, the electronic pen 100 comprises a button 168. The button 168 is disposed on the pen body 110. In this embodiment, the electronic pen 100 can generate an erasing signal according to the track of movement of the pen tip 112 after or when the button 168 is pressed, so that the electronic device 500 can erase the handwriting displayed thereon according to the erasing signal; for example, the handwriting may be partially or entirely erased, depending on the track of movement of the pen tip 112.

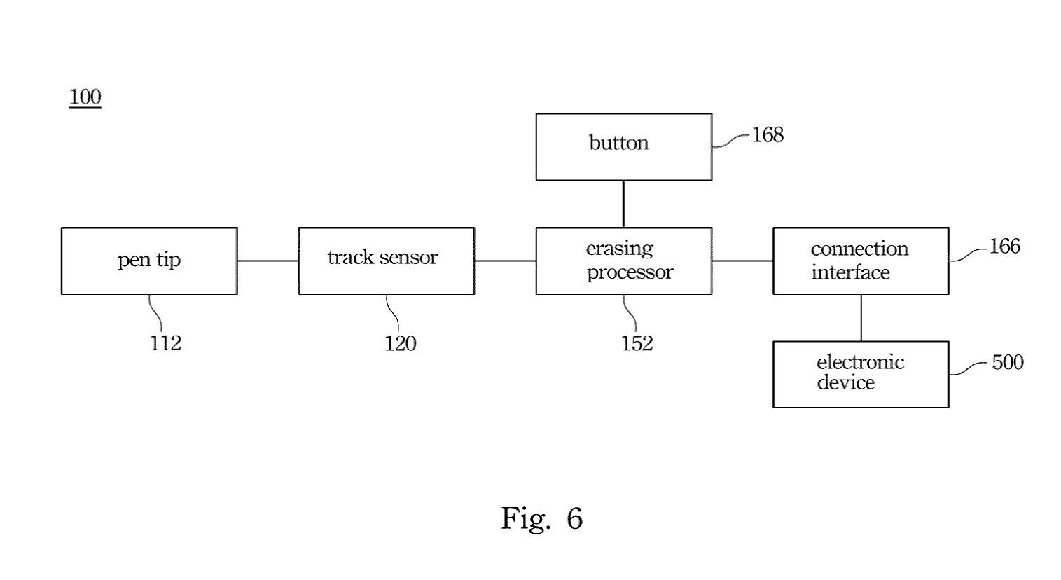

FIG. 6 is a functional block diagram of the electronic pen of FIG. 5. In FIG. 6, the electronic pen 100 comprises the pen tip 112, the button 168, the track sensor 120, the connection interface 166 and an erasing processor 152. For example, the erasing processor 152 may be a microprocessor or the like. Moreover, the erasing processor 152 and the signal processor 150 as shown in FIG. 1 may be integrated into one microprocessor; alternatively, the erasing processor 152 and the signal processor 150 may be two devices individually.

In this embodiment, the track sensor 120 can sense the track of movement of the pen tip 112. The erasing processor 152 can generate an erasing signal according to the track of movement of the pen tip 112 after or when the button 168 is pressed. The connection interface 166 can communicate the erasing signal to the electronic device 500.

In this way, the electronic device 500 can erase the handwriting displayed thereon in accordance with the erasing signal.

The readers attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. An electronic pen comprising:
a pen body having a pen tip fitted to the pen body;
a track sensor for sensing a track of movement of the pen tip;
a pressure sensor for sensing a pressure against the pen tip;
a speed calculator for calculating a speed of movement of the pen tip according to the track of movement of the pen tip;
a signal processor for converting the track of movement of the pen tip, the speed of movement of the pen tip, and the pressure against the pen tip into a handwriting signal; and
a transmission interface for communicating the handwriting signal to an electronic device.

2. The electronic pen according to claim 1, wherein the transmission interface comprises:
a Bluetooth module for communicating the handwriting signal to the electronic device according to a Bluetooth standard.

3. The electronic pen according to claim 1, wherein the transmission interface comprises a Universal Serial Bus device.

4. The electronic pen according to claim 1, further comprising:
a battery for providing the electronic pen with electric power.

5. The electronic pen according to claim 2, further comprising:
an electromagnetic coil disposed in the pen body and adjacent to an end of the pen body, wherein the end is opposite to the pen tip.

6. The electronic pen according to claim 1, wherein the pen body comprises conductive material.

7. The electronic pen according to claim 1, wherein the track sensor comprises:
a first-direction-detecting module for detecting a motion vector component in a first direction of a motion vector, wherein the motion vector represents the movement of the pen tip;
a second-direction-detecting module for detecting a motion vector component in a second direction of the motion vector, wherein the first direction and the second direction are perpendicular to each other; and
a track-calculating module for calculating the track of movement of the pen tip according to the motion vector component in the first direction and the motion vector component in the second direction.

8. The electronic pen according to claim 1, further comprising:
a memory for storing the track of movement of the pen tip, the speed of movement of the pen tip, and the pressure against the pen tip as digital data.

9. The electronic pen according to claim 1, further comprising:
a button disposed on the pen body;
an erasing processor for generating an erasing signal according to the track of movement of the pen tip after or when the button is pressed;
a connection interface for communicating the erasing signal to the electronic device.

10. The electronic pen according to claim 1, further comprising:
a connection interface disposed in the pen body.

11. The electronic pen according to claim 10, wherein the connection interface is a mini USB port.

12. An electronic pen comprising:
a pen body having a pen tip fitted to the pen body;
means for sensing a track of movement of the pen tip;
means for sensing a pressure against the pen tip;
means for calculating a speed of movement of the pen tip according to the track of movement of the pen tip;
means for converting the track of movement of the pen tip, the speed of movement of the pen tip, and the pressure against the pen tip into a handwriting signal; and
means for communicating the handwriting signal to an electronic device.

13. The electronic pen according to claim 12, wherein the means for communicating the handwriting signal to the electronic device comprises:
means for communicating the handwriting signal to the electronic device according to a Bluetooth standard.

14. The electronic pen according to claim 12, further comprising:
means for providing the electronic pen with electric power.

15. The electronic pen according to claim 13, further comprising:
an electromagnetic coil disposed in the pen body and adjacent to an end of the pen body, wherein the end is opposite to the pen tip.

16. The electronic pen according to claim 12, wherein the pen body comprises conductive material.

17. The electronic pen according to claim 12, wherein the means for sensing the track of movement of the pen tip comprises:
means for detecting a motion vector component in a first direction of a motion vector, wherein the motion vector represents the movement of the pen tip;
means for detecting a motion vector component in a second direction of the motion vector, wherein the first direction and the second direction are perpendicular to each other; and
means for calculating the track of movement of the pen tip according to the motion vector component in the first direction and the motion vector component in the second direction.

18. The electronic pen according to claim 12, further comprising:
means for storing the track of movement of the pen tip, the speed of movement of the pen tip, and the pressure against the pen tip as digital data.

19. The electronic pen according to claim 12, further comprising:
a button disposed on the pen body;
means for generating a erasing signal according to the track of movement of the pen tip after or when the button is pressed; and
means for communicating the erasing signal to the electronic device.

20. The electronic pen according to claim 12, further comprising:
a connection interface disposed in the pen body.
